(19) United States
(12) Patent Application Publication
(10) Pub. No.: US 2015/0136047 A1
(43) Pub. Date: May 21, 2015

(54) Mixed-Mode Combustion Methods Enabled by Fuel Reformers and Engines Using the Same

(71) Applicant: Deyang Hou, Sugar Land, TX (US)

(72) Inventor: Deyang Hou, Sugar Land, TX (US)

(21) Appl. No.: 14/400,583

(22) PCT Filed: May 12, 2012
(86) PCT No.: PCT/US2012/037674

§ 371 Date: Nov. 12, 2014

(51) Int. Cl. F02B 43/08; F02D 19/08; F02B 23/10; F02D 19/02; F02B 11/00

(52) U.S. Cl. CPC F02B 43/08; F02D 19/02; F02B 11/00; F02B 23/10; F02D 19/08
USPC 123/3; 123/299; 123/305; 123/527

(57) ABSTRACT

Disclosed here is an adaptive mixed-mode combustion method, which is mainly for internal combustion engines, either compression ignition or spark ignition, or mixed-mode engines using both compression ignition and spark ignition. The combustion method is composed of steps of partially charging fuel reformates through intake ports, or charging fuels with high ignition temperature through intake ports, wherein it has adaptive means to introduce fuels into combustion chamber space through both intake port fuel charge and direct fuel injections, based on engine loads and speeds, to produce a separate twin triangular heat release curves to effectively reduce emissions and fuel consumptions. A combustion engine using the disclosed combustion method is also provided. A corresponding method and fuel reformer of using exhaust energy for fuel reforming is also disclosed. Also disclosed is a rotating fuel reformer, comprising a rotating catalyst block to accelerate the fuel reforming rate and reduce the reformer weight and catalyst usage. The reformer also has devices to pressurize and atomize fuel through centrifugal forces.

### CROSS REFERENCE TO RELATED APPLICATION

This application is the National Stage Entry of PCT/US2012/037674.

### BACKGROUND OF THE INVENTION

1. Field of the Invention

The present invention relates to combustion methods and fuel reformers, and an internal combustion engine using the same, either compression ignition or spark ignition, or mixed-mode combustion engine using both compression ignition and spark ignition.

2. Description of the Related Art

While the engine industries have put great efforts for Homogenous Charge Compression Ignition (HCCI) and Premixed Charge Compression Ignition (PCCI) combustion, the conventional multi-hole fuel injector limits the operation maps of HCCI and PCCI and flexibility for combination of different combustion modes in the same engine power cycle. The major reasons are the fixed injection spray angle and dense jet nature of conventional multijet sprays. Since current HCCI or PCCI can only operate in low to medium loads in practical applications, conventional fixed-spray-angle nozzle designs have to be compromised for low and high loads. A larger spray angle for high loads will bring severe wall (cylinder liner) wetting issues for early injections dictated by HCCI/PCCI mixture formation requirements. The major wetting issues are associated with high HC and CO emissions and lower combustion efficiency. A fixed narrower spray angle optimized for premixed combustion will generate more soot formation for high loads. Higher soot formation also reduces fuel efficiency.

Thus, a variable spray angle or using different spray angel injection and penetration are much better positioned to solve this contradiction between the requirements for different injection timings and operation loads. The innovative design of said combustion method has solved this wall-wetting issue through providing a variable spray angle or using different spray angles, as shown in FIG. 3, which is smaller for early injection and becomes larger for late injection, and a variable spray pattern or different spray patterns, which is formed with smaller holes with smaller spray angles for early injection with less penetration strength, and tends to larger multi-jets for late injection with higher penetration strength. Such a variable spray angle combustion method is documented in WO 2011/008706 A2, as shown in FIG. 3.

Alternatively to the above variable spray angle solution, partially charge fuel through intake port is another solution. Considering that port charged fuel will endure long time of compression stroke, avoiding early ignition during compression stroke become paramount to ensure a stable engine operation. Thus, fuels with higher ignition temperatures or lower cetane number (or high octane number) such as gasoline, ethanol, methane etc are preferred fuel than diesel fuels for premixed combustion. On another side, reforming diesel fuel into syngas (hydrogen and carbon monoxide) which has high ignition temperature than diesel fuel will enable partially charging diesel reformates through intake ports. This approach can leverage the benefit of low ignition temperature of diesel fuel which is good for diffusion combustion and high ignition temperature syngas or reformates which is good for premixed compression combustion without concerns of pre-ignition.

Partially charging syngas through intake ports has demonstrated capabilities of reducing engine out nitride oxide and particular matters. Syngas has higher ignition point, thus it is helpful for control ignition timings. Considering that port charged fuel will endure long time of compression stroke, avoiding early ignition during compression stroke become paramount to ensure a stable engine operation. Thus, fuels with higher ignition temperature or lower cetane numbers (or high octane number) such as gasoline, ethanol, methane etc are preferred than diesel fuels for premixed combustion. On another side, reforming diesel fuel into syngas (hydrogen and carbon monoxide) which has high ignition temperature than diesel fuel itself will enable partially charging diesel reformates through intake ports. This approach can leverage the benefit of low ignition temperature of diesel fuel which is good for diffusion combustion and high ignition temperature syngas or reformates which is good for premixed compression combustion without concerns of pre-ignition.

There are three major areas for diesel fuel reformer applications: directly provide reformed syngas/reformate along with EGR to improve in-cylinder combustion; supply reformate as a reductant along with exhaust gas for enhancing the efficiency and operating temperature window of NOx absorber and PM traps devices; directly supply reformate for fuel cell applications;

There are three major processes can be used to reform diesel fuel: steam reforming, partial oxidation reforming, and autothermal reforming. Autothermal reformers (ATRs) combine some of the best features of steam reforming and partial oxidation systems. In autothermal reforming, a hydrocarbon feed is reacted with both steam and air to produce a hydrogen-rich gas. Both the steam reforming and partial oxidation reactions take place. With the right mixture of input fuel, air and steam, the partial oxidation reaction supplies all the heat needed to drive the catalytic steam reforming reaction. This makes autothermal reformers simpler and more compact than steam reformers. Autothermal reformers typically offer higher system efficiency than partial oxidation systems, where excess heat is not easily recovered.

Getting the reformer to convert diesel fuel to hydrogen or hydrogen rich syngas posed a whole new set of challenges because diesel is difficult to vaporize. The vaporization of diesel fuel requires high temperatures, which lead to pyrolysis and coking (carbonaceous deposits). The disclosed design of a atomizer with an rotating arm, can produce ultra-fine atomization of diesel fuel through leveraging the high pressure produced by the centrifugal forces of the rotating arm, will directly address above application issues.

On another side, fuel reforming process is a diffusion controlled process. Most current fuel reformers are stationary devices with small catalyst channels. The flow velocity inside the catalyst channels is very slow. Thus it demands a significant weight and volume for the fuel reformer to supply sufficient mass flow rate of syngas for an internal combustion engine and other combustion devices. Methods which can accelerate the reforming and flow velocity inside the catalyst without scarifying the chemical reactions is critical for mobile applications.

Further, current fuel reformers use catalyst which quite often demands significant amount of rare earth elements. Considering the high cost and limited resources of rare earth metals, it is critical to reduce the rare earth usage.

### SUMMARY OF THE INVENTION

Disclosed here is an adaptive mixed-mode combustion method, which is mainly for internal combustion engines, either compression ignition or spark ignition, or mixed-mode engines using both compression ignition and spark ignition. The combustion method is composed of steps of partially charging fuel reformates through intake ports, or charging fuels with high ignition temperature through intake ports, wherein it has adaptive means to introduce fuels into combustion chamber space through both intake port fuel charge and direct fuel injections, based on engine loads and speeds, to produce a separate twin triangular heat release curves to effectively reduce emissions and fuel consumptions. A combustion engine using the disclosed combustion method is also provided. The disclosed combustion method can significantly reduce soot and nitride oxygen emission formation and fuel consumption.

A premixed charge of fuel and air is desirable for reducing emissions. However, for high engine loads, if all fuel and air is premixed before TDC, in the event of out of controlled combustion before TDC, the sudden release of all the heat energy could damage the engine. Thus, at high engine loads, only partially premix fuel and air before TDC is desirable.

Until recently, most internal combustion engines using open loop control due to lacks of cost effective in-cylinder pressure sensors or other reliable sensor feedbacks. It is also due to the fact of the complexity associated with real time control and lacking of a simple effective guiding rules to dynamically adjust the key operating parameters such as fuel injection timings and quantity ratios. The look-up table which was predefined during engine calibration is not sufficient to adapt to real engine operating environment which generally different from calibration conditions. The simple criteria of setting the heat release centroid to an optimized predetermined crank angle provide a simple but yet effective means to optimize engine thermal efficiency in real time based on real time in-cylinder pressure measurement. The simple rule of separating the heat release of premixed combustion with that of main injection diffusion combustion forms an effective means to reduce NOx emissions due to the simple fact of reducing high temperature crank angle window due to high peak heat release.

However, reforming fuel demands significant energy, and the exhaust gas contains significant waste energy, thus, harvesting the energy in exhaust gas to heat the reactor core of the fuel reformer is a fundamentally sound approach. In this continuation-in-part work, we disclose the method and devices to utilize the waste energy to reform fuel into syngas for supplying into engine intake ports.

It is our goal for this invention to address at least some of the concerns currently encountered in applications of fuel reformers.

It is our goal to reduce the amount of rare earth metals needed through only filling partial of the catalyst blocks with catalyst media and providing catalytic functions for the whole reformer space by rotation motion of the catalyst blocks. This operation is similar to rotating fan blades to cover a space. Even though there are only a few blades, the whole space looks like covered by blades when the fan is in high speed rotation. The energy needed to drive the fuel reformer can come from exhaust flow energy.

It is also our goal for this invention to improve fuel atomization through leveraging the high pressure generated when an arm is at high rotating speed. The centrifugal forces can generate high injection pressure for the fuel to be atomized. This improves the uniformity of the fuel and air mixture for the reformer.

It is our goal for this invention to leverage the function of a compressor structure for the fuel reformer, thus it can recover partial of the exhaust energy for compressing the reformates or syngas.

It is our goal for this invention to leverage the function of a turbo structure filled with porous catalyst media to do at least partial after-treatment for the exhaust gas. Thus, we propose a fuel reformer with rotating catalyst block which is only partially filled with porous catalyst media, the catalyst block can be rotated by a rotation driver such as exhaust turbo to cover the whole reforming space without the need of filling all the space with catalyst media. The reformer may utilize a rotating arm to provide well atomized fuel and well mixed fuel-air mixture for the reformer.

### DESCRIPTION OF THE DRAWINGS

FIG. 1 is an illustration of heat release for conventional diffusion combustion. Initial heat (11) release is associated with high NOx formation and is overlapped with main heat release (12).

FIG. 2 is an illustration of heat releases for said Adaptive Mixed-Mode Combustion method. First heat release (21) is associated with clean early premixed combustion of syngas charges or similar low cetane number fuels, such as natural gas, biomethane, ethanol, etc., through intake ports, thus reduces diffusion combustion heat release of main direct injections (22). The twin triangular heat release reduces emissions and provides more flexibility for thermal efficiency optimization. The vertical line (2C) is the Centroid line of heat releases, which can be dynamically set to an optimized crank angle to optimize combustion.

FIG. 3 is an illustration of prior art using variable spray angle injection strategies.

FIG. 4 is an illustration of fuel charged at different injection timings for the mixed mode combustion enabled by partially charging fuel through intake ports, with late direct injection around TDC similar to conventional diesel combustion. 411—fuels charged through intake ports; 421—pilot direct injection with small quantity for premixed combustion; 422—main direct injection for conventional combustion; 423—optional post direct injection; 43—main injection spray patterns;

FIG. 5 is an illustration of the internal combustion engine using the said combustion methods with a fuel reformer:

51—master engine block; 511—air intake ports charged with partial fuel; 512—fuel injection system; 513—exhaust loop; 514—exhaust gas recirculation (EGR) loop, passed through reformer (52) for heating purpose, and connected to intake port (511) through mixing with syngas/reformates (524);
52—fuel reformer; 521—fuel injection device of fuel reformer; 522—air inlet of fuel reformer; 523—optional steam inlet of reformer for autothermal reforming; 524—syngas charge from fuel reformer coupled with engine air intake port;

FIG. 6 is an illustration of the internal combustion engine using the said combustion methods with a fuel reformer using different fuel than master engine. FIG. 6 is same as FIG. 5 except fuel tank 624 for a different fuel than master engine, 621—independent fuel injection device.

FIG. 7 is an illustration of the internal combustion engine using the combustion method with a fuel reformer, which is directly incorporated into the high pressure EGR loop:

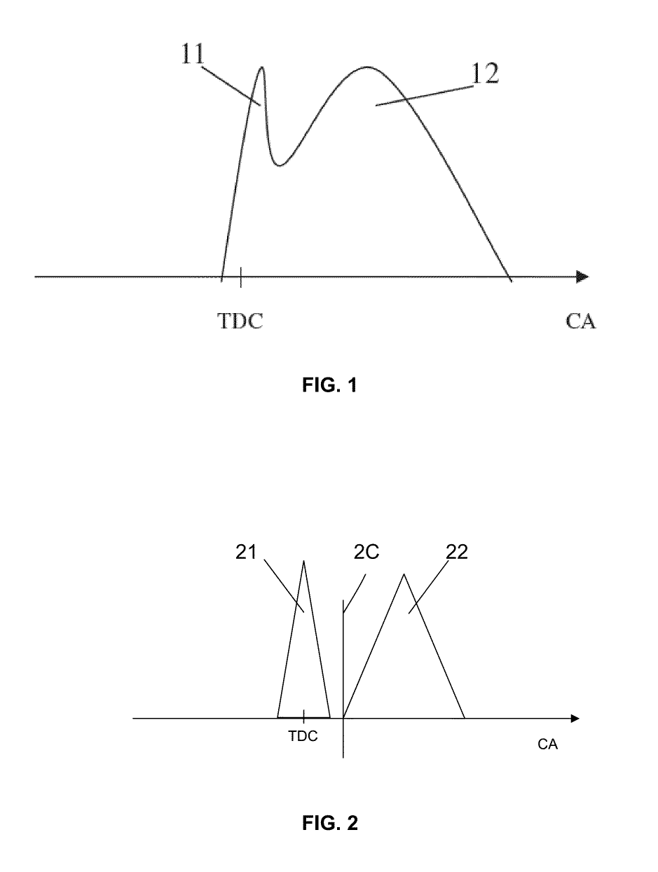

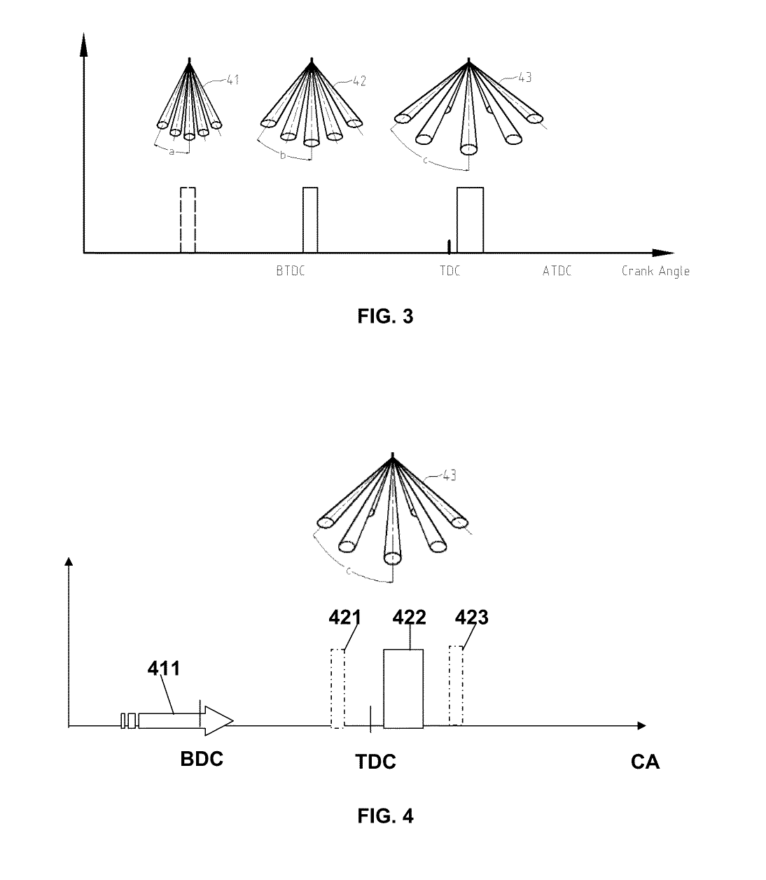

51—master engine block; 511—air intake ports charged with partial fuel; 512—fuel injection system; 513—exhaust loop; 514, 515—exhaust gas recirculation (EGR) loop, passed through reformer (52) for heating purpose, and being connected to intake port (511) through mixing with syngas/reformates (524), or any other second fuel;
52—fuel reformer; 721—independent fuel injection device of fuel reformer; 724—fuel tank for a same or different fuel than master engine main fuel, 522—optional air inlet of fuel reformer; 523—optional steam inlet of reformer for autothermal reforming; 524—syngas charge from fuel reformer coupled with engine air intake port (510);

FIG. 8 is an illustration of the high pressure EGR loop which has been incorporated with a fuel reformer. 52—fuel reformer section of the EGR loop, 515—high pressure EGR pipe containing EGR only, 524 high pressure EGR loop containing reformates or second fuel and EGR;

FIG. 9 is a detailed illustration of the fuel reformer, which is directly incorporated into the high pressure EGR loop: 5201—reformer shell; 5202—swirl generator; 5203—reformer catalyst reactor core; 5204—fuel spray; 5205—swirl; 516—high temperature EGR;

FIG. 10 is an illustration of the left side section view of fuel reformer, which is directly incorporated into the high pressure EGR loop: 5203a—reformer catalyst core; 5203b—reformer heat transfer fin, which absorbs exhaust energy from EGR stream; 5201a—reformer flange; 5201b—reformer shell bolt hole;

FIG. 11 is a demonstration of the general composition of the rotating reformer.

FIG. 11 (a) is overall sketch of the reformer; FIG. 11(b) is an illustration for the coupling shaft, in which,
1—reformer: 104-reformat (syngas) exit; 105—fuel inlet; 106—optional steam inlet; 107—air inlet.
2—turbo; 12—coupling shaft; 1201—shaft for rotation driver (2), 1202—shaft for reformer (1); 1203—gear connected to 1201; 1204—gear connected to 1202; 3—fuel tank; 4—control valve.

FIG. 12 is a demonstration of a first embodiment of the rotating reformer.

FIG. 12 (a) is overall sketch of the reformer; FIG. 12(b) is a side view of the rotating arm 101; FIG. 12(c) is a side view for the catalyst rotor (103).
1—reformer: 101—rotating arm; 102-fuel spray orifice; 103—catalyst rotor; 103a—catalyst block; 103b—space between catalyst blocks; 103c—shaft;
104—reformate (syngas) exit; 105—fuel inlet; 106—optional steam inlet; 107—air inlet
2—turbo: 201—exhaust gas inlet; 202—blades; 203—exhaust gas outlet;
3—fuel tank; 4—control valve.

FIG. 13 is a demonstration of a second embodiment of the rotating reformer.

FIG. 13 (a) is overall sketch of the reformer; FIG. 13(b) is a side view of the rotating arm (101′); FIG. 13(c) is a side view for the catalyst rotor (103).
1—reformer: 101′—rotating arm; 102′—smashing bar; 103—catalyst block;
104—reformat (syngas) exit; 105 —fuel inlet; 106—optional steam inlet; 107—air inlet
2—turbo: 201—exhaust gas inlet; 202—blades; 203—exhaust gas outlet;
3—fuel tank; 4—control valve.

FIG. 14 is a demonstration of a third embodiment with a compressor like structure for the reformer (1).

FIG. 14 (a) is an overall sketch; FIG. 14(b) is a side view of the reformer.
103′—compressor like structure; 103′a—blades; 103′b—catalyst porous media;
103′c—shaft;

FIG. 15 is a demonstration of a forth embodiment with a turbo structure filled with catalyst media for the rotation driver (2).
2—turbo like structure; 201—exhaust inlet; 202—blades; 203—exhaust outlet;
204—catalyst porous media; 205—shaft;

### DESCRIPTION OF THE PREFERRED EMBODIMENTS

### Description of the Mixed-Mode Combustion Method

Disclosed here is a mixed-mode combustion method, which is mainly for internal combustion engines, comprising steps of: (i) introducing fuel into engine combustion chamber through both air intake ports and through direct fuel injections into combustion chamber with at least one fuel injector per cylinder; (ii) setting the direct fuel injection timings and fuel quantities based on engine speeds and loads, (iii) introducing fuel into the combustion chamber with an optional small pilot direct fuel injection before engine top dead center (TDC), with at least one main direct fuel injection after TDC, and with an optional post direct fuel injection after said main direct fuel injection, in the same engine power cycle respectively, (iv) adjusting direct fuel injection timings such that the accumulated heat releases from the intake port fuel charge and main direct fuel injections are separate sequential events, with the heat release from the intake port fuel charge happens first and ends, then after the heat release from main direct fuel injections follows; (v) dynamically readjusting fuel quantities and injection timings for the port fuel charge and direct fuel injections such that the crank angle of the centroid of the separated heat releases from intake port fuel charge and direct fuel injections is close to a predetermined crank angle point which tends to maximize the engine thermal efficiency and minimize engine emissions. As shown in FIG. 2, FIG. 4.

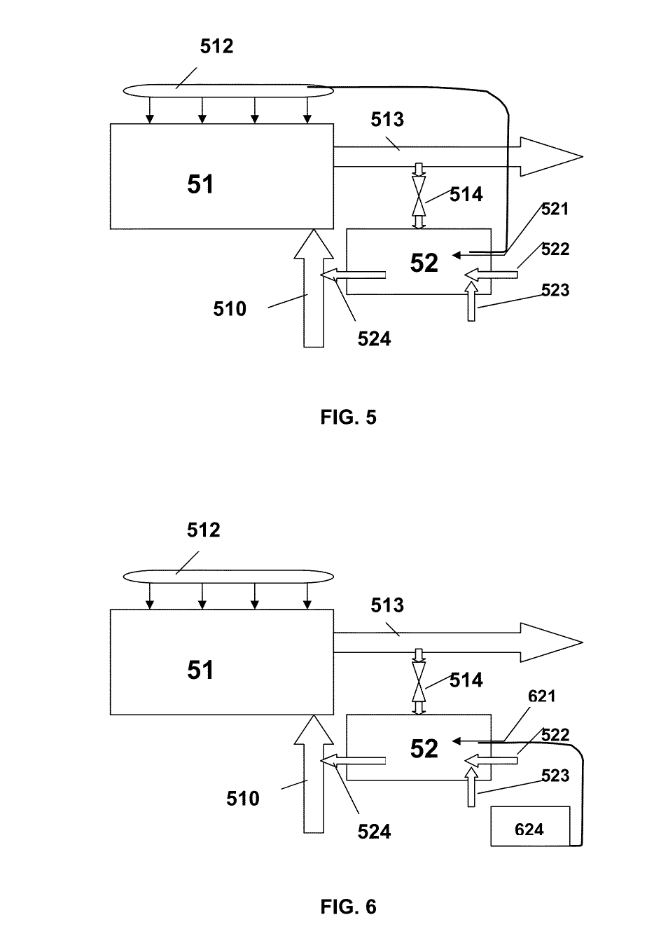

For the above described combustion method, where in the fuel charged from intake ports is syngas (hydrogen and monoxide) reformed outside the engine (51) with a fuel reformer (52) using the same fuel as the fuel being direct injected into engine combustion chamber. As shown in FIG. 5.

For the above described combustion method, where in the fuel charged from intake ports is syngas (hydrogen and monoxide) reformed outside the engine (51) with a fuel reformer (52) using a different fuel, such as biofuels, than the fuel being direct injected into engine combustion chamber.

For the above described combustion method, where in the fuel charged from intake ports is any fuel bearing higher compression ignition temperature which has lower cetane number than the fuel being direct injected into engine combustion chamber. For example, the port injection fuel can be ethanol, E85, methane, and the direct injection fuel can be diesel fuel or biodiesel fuel.

For the above described combustion method, where in the heat release is calculated through integrating the pressure gradients obtained by measured in-cylinder pressure data.

For the above described combustion method, wherein it has:
a. at least one main direct fuel injection into combustion chamber conducted approximately between −5˜30 degree after TDC, preferably starting at 0˜15 degree crank angle after TDC with multi-jet sprays;
b. one optional pilot direct fuel injection into combustion chamber with small fuel quantity conducted approximately between −30˜0 degree after TDC;
c. one optional direct fuel injection into combustion chamber with small fuel quantity conducted approximately between 20˜40 degree after TDC;

An internal combustion engine using the above described combustion method, wherein the said crank angle of the centroid of heat releases from fuel being charged through intake port and from direct injected fuel falls approximately between 5˜20 degree after TDC, and the heat releases resemble a separated twin triangular-like shapes;

In another exemplary internal combustion engine using the described combustion method, as shown in FIG. 5, has following integrated features: the fuel supplied through intake ports is syngas (hydrogen and monoxide) being provided through an fuel reformer (52), and the fuel for the fuel reformer comes from the fuel injection system of the master engine (51); and the fuel injector for the reformer acts like a fuel injector for an additional engine cylinder with injection duration tuned for the fuel reformer;

In another exemplary internal combustion engine using the described combustion method, as shown in FIG. 6, has following integrated features: the fuel charged through intake ports is syngas (hydrogen and monoxide) being provided through a fuel reformer (51), and the fuel for the fuel reformer comes from an independent fuel injection device, and the fuel for the reformer can be different than the fuel for the master engine.

In another exemplary internal combustion engine using the described combustion method, characterized by:
a. for said engine at low to medium engine loads, with approximately 20˜50% of total fuel is introduced through intake ports, and the rest of the fuel being directly injected approximately between −5˜30 degree after TDC, preferably starting between 0˜15 degree after TDC;
b. for said engine at above medium to full engine loads, fuel introduced from intake ports is approximately 5˜20% of total fuel for the power cycle.

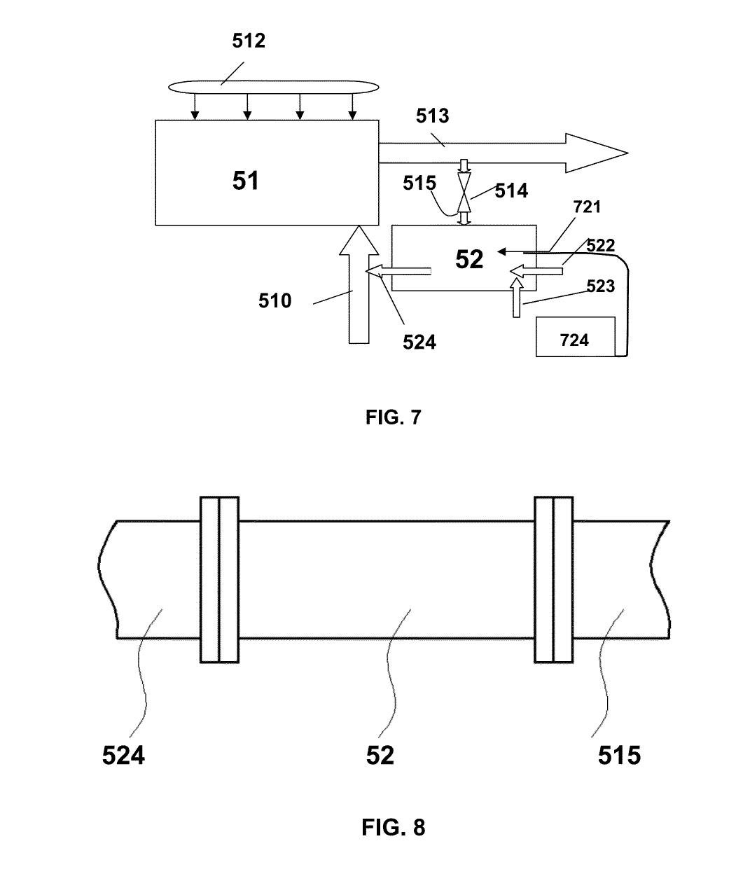

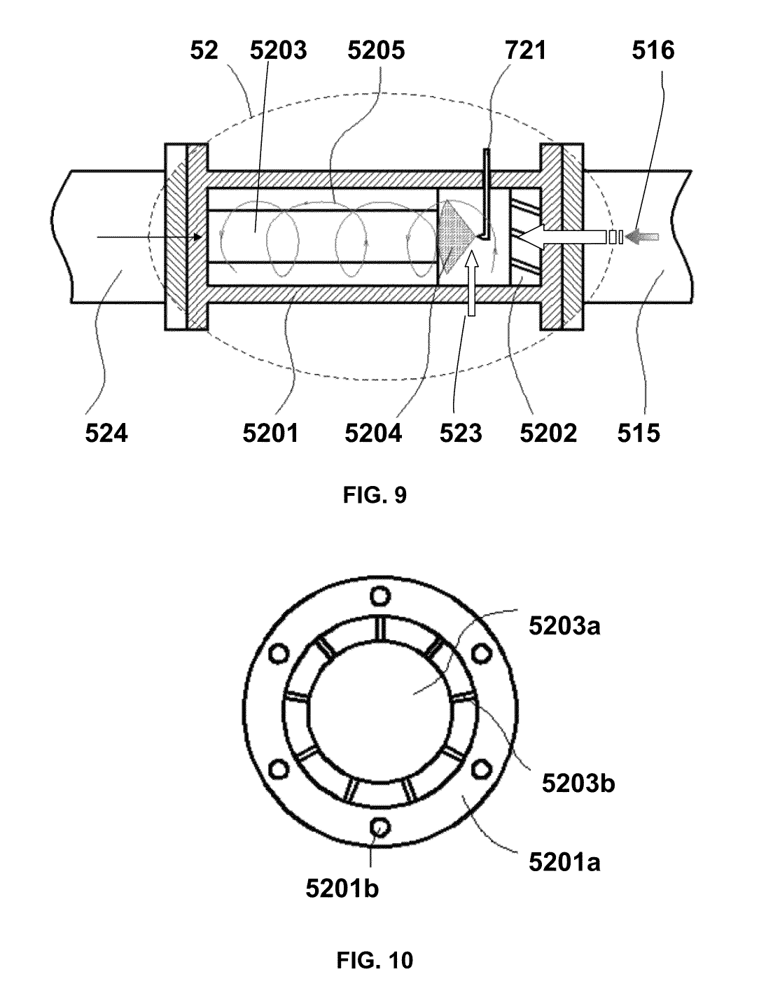

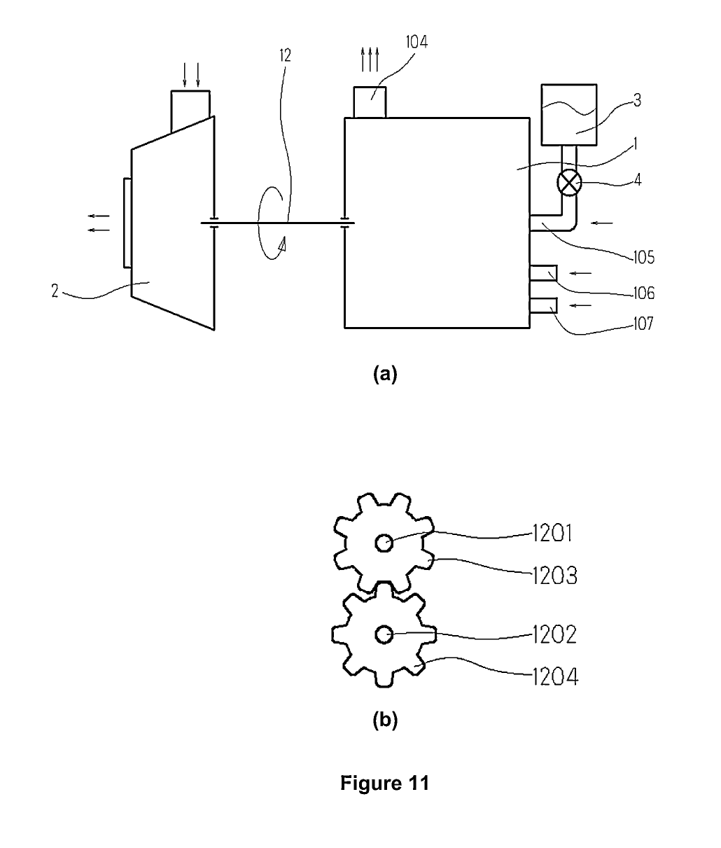

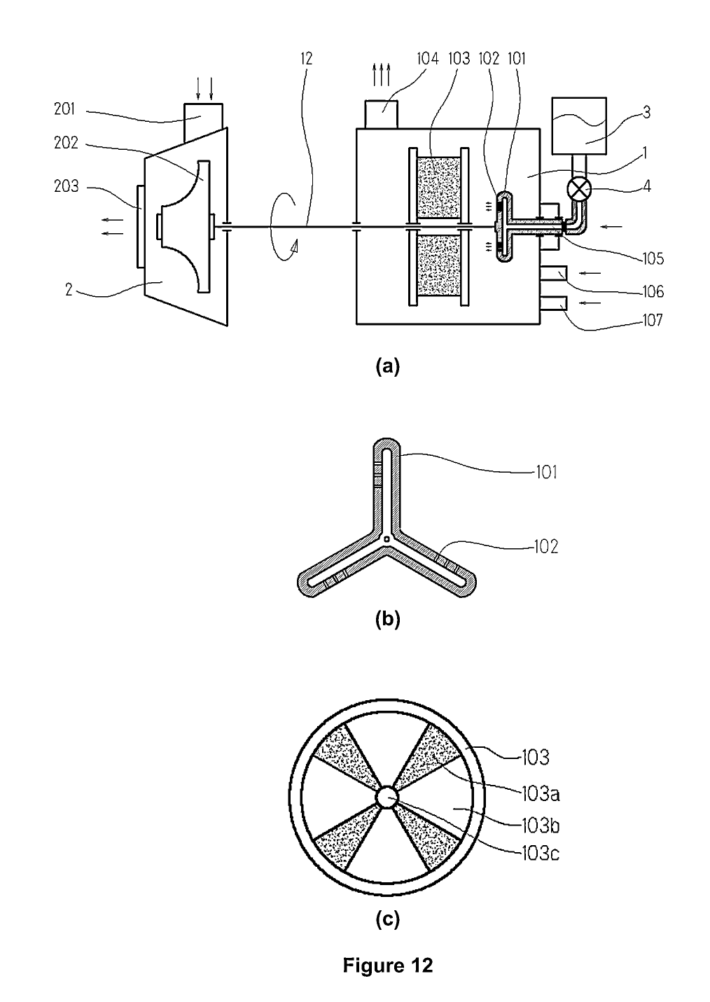

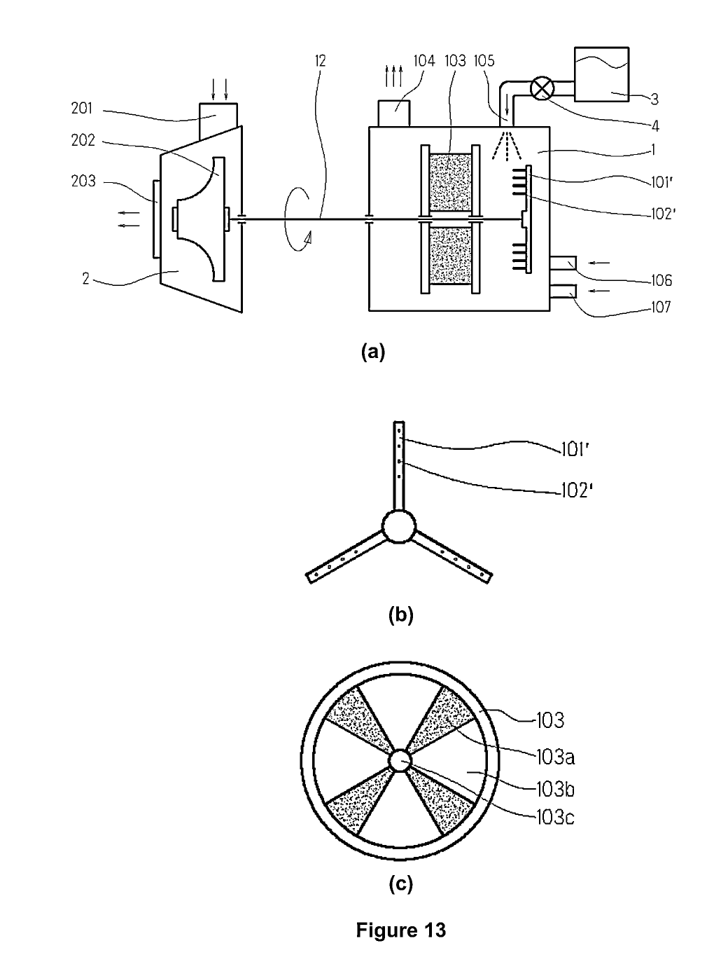

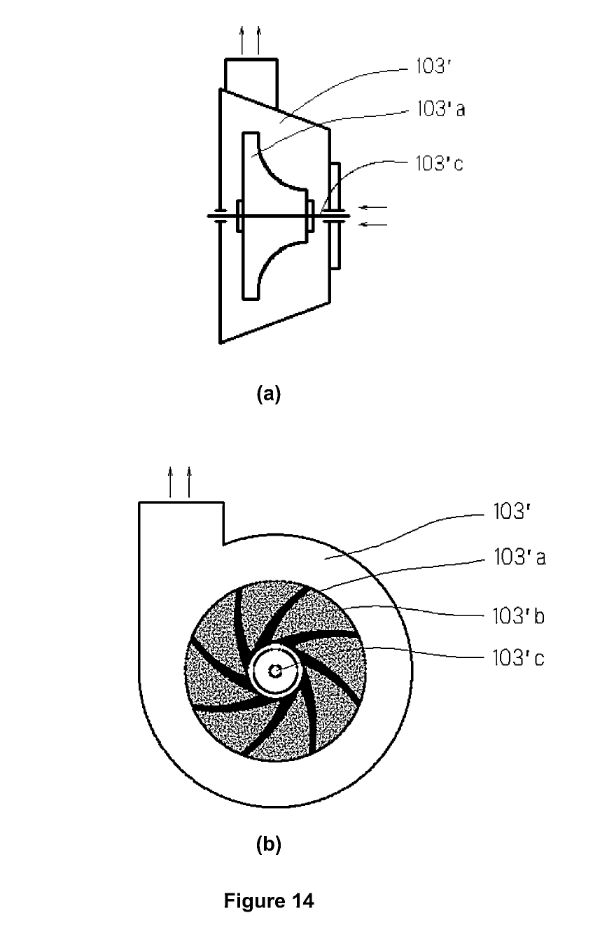

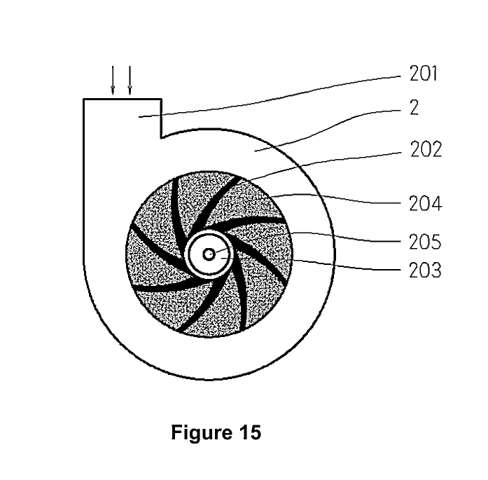

In order to utilize the exhaust energy of the exhaust gas, we can fit a fuel reformer directly into the exhaust gas pipe, preferably high pressure EGR loop of an engine, as shown in FIGS. 7, 8 and 9. Thus, we form a method of utilizing exhaust gas energy to heat fuel reformer, comprising steps of: (i) fitting the fuel reformer, which has means to absorb waste energy, into a high pressure exhaust gas recirculation (EGR) loop; (ii) guiding the EGR passing through the reformer; (iii) injecting fuel into the fuel reformer along with an optional injection of steam into the fuel reformer; (iv) supplying the fuel reformates/syngas into air intake ports of engine devices, such as internal combustion engines, gas turbine engines, etc.

The fuel being injected into the fuel reformer can be the same as fuel injected into the main engine.

The fuel being injected into the fuel reformer can be a second fuel, such as methane, ethanol, butanol, biomethane, which is different from the fuel being injected into main engine, which can be diesel fuel, biodiesel fuel, gasoline fuel etc.

A fuel reformer, which is directly coupled into exhaust gas loop to use exhaust energy, composing of: (i) a reformer shell to hold the catalyst reactor core; (ii) at least one fin to absorb exhaust energy from the exhaust gas and to heat the catalyst reactor core; (iii) a fuel injector, which introduces a fuel into the fuel reformer, (iv) a swirl generator, which promotes homogeneous mixing between exhaust gas and fuel; (v) an optional steam generator, which injects steam into the reformer; (iii) an optional air inlet which injects air into the fuel reformer.

The above fuel reformer, can further use autothermal reforming process, wherein steam is injected into the fuel reformer.

The above fuel reformer, can further utilize partial oxidation reforming process.

The above fuel reformer, wherein the fuel being injected into the reformer is methane or natural gas, and methane is reacted with carbon dioxide in exhaust loop to form syngas (carbon monoxide and hydrogen) through dry reforming process, thus it reduces carbon dioxide emissions and improves energy efficiency of engines.

Refer to FIG. 11, A fuel reformer (1), comprising: a fuel inlet (105), an optional steam inlet (106), an air inlet (107), a catalyst rotor (103) inside of (1) (not shown in FIG. 11), an reformate outlet (104), wherein the fuel is reformed into carbon monoxide and hydrogen, where in the fuel reformer has means of connecting to a rotation driver (2) through a rotation coupling shaft (12) to accelerate the reforming process and the flow of reformates.

Refer to FIG. 11(b), a fuel reformer, wherein the rotation coupling shaft (12) is driven by a turbo (2). In other embodiments, the rotation coupling shaft (12) can also be driven by at least one of following means: an electric motor, a turbine, an internal combustion engine. With exhaust turbo as preferred driving means since it uses exhaust flow energy.

Refer to FIG. 12, a fuel reformer of FIG. 11, wherein it further has means of supplying fuel by an atomizer with a rotating arm (101) which has multiple atomization orifices (102), wherein the fuel is pressured by the centrifugal force of (101) and atomized through rushing out its orifices (102). Supplying high pressure fuel is always a challenge since it usually demands high pressure pumps. With the disclosed rotating arm, the fuel can be pressed into high pressure without demanding a high pressure fuel pump. This is especially meaningful for low viscosity fuels such as gasoline, ethanol, etc.

Refer to FIG. 12(c), a fuel reformer of claim 1, wherein the catalyst rotor (103) is only partially filled with catalyst block (103a) in circular direction to reduce weight and save usage of catalyst.

Refer to FIG. 12(a), FIG. 13(a), a fuel reformer, wherein the air inlet (107), the steam inlet (106) is co-axial with the said rotation coupling shaft (12).

Refer to FIG. 12(a), FIG. 13(a), a fuel reformer, wherein the air inlet (107), the steam inlet (106) is offset with the said rotation coupling shaft (12).

Refer to FIG. 11(a), a fuel reformer, wherein the rotation coupling shaft is a single shaft connection between the fuel reformer (1) and the rotation driver (2).

Refer to FIG. 13, a fuel reformer of claim 1, wherein it has means of supplying fuel by a injection nozzle (105), wherein the injected spray is further atomized by the smashing force of the rotating arm (101′) which has small smashing bars (102′) fixed on it. The smashing bars promotes the mixing between air stream and fuel sprays, thus can provide more homogenous mixture.

Refer to FIG. 14, an embodiment of the fuel reformer of FIG. 11, wherein it is further comprising a compressor structure for the catalyst rotor (103′), with porous media like catalyst blocks (103′b) being filled between compressor blades (103′a). The catalyst block is rotated around its shaft (103′c).

Refer to FIG. 15, an embodiment of the fuel reformer of FIG. 11, wherein it is further comprising a turbo structure for the rotation driver (2) which has an exhaust gas inlet (201), exhaust gas outlet (203), a rotating shaft (205), with porous media like catalyst blocks (204) being filled between turbo blades (202), wherein it has means to cleanse the nitride oxide and particular matters from the exhaust gas while driving the reformer (1). This embodiment combines the function of NO(sub)x and particular matter after-treatment with the turbo structure.

Refer to FIG. 11(a), a fuel reformer of claim 1, wherein the axis of the said fuel reformer (1) and rotation driver (2) is offset, wherein the rotation coupling shaft (12) delivers rotation through at least one of the following means: through gears to couple the rotations between the fuel reformer (1) and the rotation driver (2), through belt to couple the rotations between the fuel reformer (1) and the rotation driver (2).

Refer to FIG. 12 (c) and FIG. 13(c), the porous medium for the catalyst block can be the same as current commonly used catalyst blocks. The catalyst blocks can also be filled with micro wire stacks coated with nano structure catalyst layers. Such a nano structure can be fur like or simply with nano particles coated on the catalyst base surfaces. A preferred embodiment is to fill the catalyst block with micro copper wires as catalyst monolith being coated with catalyst, such as Rh/Al(sub)2O(sub)3.

The materials for the rotating arm (101) in FIG. 12 can be stainless steel or other tool steels. The orifice (102) size should be fabricated based on the fuel flow rate. To ensure good atomization, the orifice diameter should be generally less than 300 microns.

For those familiar with the atomization and reforming art, it can be easily to modify the design presented here with other design details follow the same design fundamentals to fit in specific needs. Thus, such design ramifications are considered as being covered by this invention.

What is claimed is:

1. A mixed-mode combustion method, which is mainly for internal combustion engines, comprising steps of: (i) introducing fuel into engine combustion chamber through both air intake ports and through direct fuel injections into combustion chamber with at least one fuel injector per cylinder; (ii) setting the direct fuel injection timings and fuel quantities based on engine speeds and loads, (iii) introducing fuel into the combustion chamber with an optional small pilot direct fuel injection before engine top dead center (TDC), with at least one main direct fuel injection around TDC, and with an optional post direct fuel injection after said main direct fuel injection, in the same engine power cycle respectively, (iv) adjusting direct fuel injection timings such that the accumulated heat releases from the intake port fuel charge and main direct fuel injections are separate sequential events, with the heat release from the intake port fuel charge happens first and ends, then after the heat release from main direct fuel injections follows; (v) dynamically readjusting fuel quantities and injection timings for the port fuel charge and direct fuel injections such that the crank angle of the centroid of the separated heat releases from intake port fuel charge and direct fuel injections is close to a predetermined crank angle point which tends to maximize the engine thermal efficiency and minimize engine emissions;

2. A combustion method of claim 1, where in the fuel charged from intake ports is mainly syngas which is composed of hydrogen and carbon monoxide (CO) reformed outside the engine with a fuel reformer using the same fuel as the fuel being direct injected into engine combustion chamber;

3. A combustion method of claim 1, where in the fuel charged from intake ports is mainly syngas which is composed of hydrogen and carbon monoxide reformed outside the engine with a fuel reformer using a different fuel than the fuel being direct injected into engine combustion chamber;

4. A combustion method of claim 1, where in the fuel charged from intake ports is any fuel bearing higher compression ignition temperature which has lower cetane number than the fuel being direct injected into engine combustion chamber;

5. A combustion method of claim 1, where in the heat release is calculated through integrating the pressure gradients obtained by measured engine in-cylinder pressure data;

6. A combustion method of claim 1, wherein it has:
(a) at least one main direct fuel injection into combustion chamber conducted approximately between −5˜30 degree after TDC, preferably starting at 0˜15 degree crank angle after TDC with multi jet sprays;
(b) one optional pilot direct fuel injection into combustion chamber with small fuel quantity conducted approximately between −30˜0 degree after TDC;
(c) one optional post direct fuel injection into combustion chamber with small fuel quantity conducted approximately between 20˜40 degree after TDC;

7. An internal combustion engine using the combustion method of claim 1, wherein the said crank angle of the centroid of heat releases from fuel being charged through engine air intake ports and from direct injected fuel falls approximately between 0˜20 degree after TDC, and the heat releases resemble a separated twin triangular-like shapes;

8. An internal combustion engine of claim 7, where in the fuel supplied through intake ports is mainly syngas which is composed of hydrogen and carbon monoxide being provided through a fuel reformer, the fuel for the fuel reformer comes from the fuel injection system of the master engine, and the fuel injector for the reformer acts like a fuel injector for an additional engine cylinder with injection duration tuned for the fuel reformer;

9. An internal combustion engine of claim 7, where in the fuel charged through intake ports is syngas which is mainly composed of hydrogen and carbon monoxide being provided through an fuel reformer, and the fuel for the fuel reformer comes from an independent fuel injection system than that of master engine;

10. An internal combustion engine of claim 7, characterized by:
(a) for said engine at low to medium engine loads, with approximately 20˜50% of total fuel is introduced through air intake ports, and the rest of the fuel being injected approximately between −5˜30 degree after TDC, preferably starting between 0˜15 degree after TDC;
(b) for said engine at above medium to full engine loads, fuel introduced from intake ports is approximately 5˜20% of total fuel for the power cycle.

11. A method of utilizing exhaust gas energy to heat fuel reformer, comprising steps of: (i) fitting the fuel reformer, which has means to absorb waste energy, into a high pressure exhaust gas recirculation (EGR) loop; (ii) guiding the EGR passing through the reformer; (iii) injecting a fuel into the fuel reformer along with optional injecting steam into the fuel reformer; (iv) supplying the fuel reformates/syngas into air intake ports of engine devices.

12. A method of claim 11, which is mainly for internal combustion engines and gas turbine engines, wherein the fuel being injected into the fuel reformer is the same as fuel injected into the main engine.

13. A method of claim 11, which is mainly for internal combustion engines and gas turbine engines, wherein the fuel being injected into the fuel reformer is a second fuel which is different from fuel injected into the main engine.

14. A fuel reformer, which is directly coupled into exhaust gas pipe to use exhaust energy, composing of: (i) a reformer shell to hold the catalyst reactor core; (ii) at least one fin to absorb exhaust energy from the exhaust gas and to heat the catalyst reactor core; (iii) a fuel injector, which introduces fuel into the fuel reformer, (iv) a swirl generator, which promotes homogeneous mixing between exhaust gas and fuel; (v) an optional steam generator, which injects steam into the reformer; (iii) an optional air inlet which inject air into the fuel reformer.

15. A fuel reformer of claim 14, further uses autothermal reforming process, wherein steam is injected into the fuel reformer.

16. A fuel reformer of claim 14, further utilizes partial oxidation reforming process, no steam is injected into the reformer.

17. A fuel reformer of claim 14, wherein the fuel being injected into the reformer is methane or natural gas, and methane is reacted with carbon dioxide in exhaust loop to form syngas (carbon monoxide and hydrogen) through dry reforming process, thus reduce carbon dioxide emissions.

18. A fuel reformer (1), comprising: a fuel inlet (105), an optional steam inlet (106), an air inlet (107), a catalyst rotor (103), an reformate outlet (104), wherein the fuel is reformed into carbon monoxide and hydrogen, wherein the fuel reformer has means of connecting to a rotation driver (2) through a rotation coupling shaft (12) to accelerate the reforming process and the flow of reformates.

19. A fuel reformer of claim 18, wherein it is further composing a compressor structure for the catalyst rotor (103′), with porous media like catalyst blocks (103′b) being filled between compressor blades (103′a) and being rotated around its shaft (103′c).

20. A fuel reformer of claim 18, wherein it is further composing a turbo structure for the rotation driver (2) which has an exhaust gas inlet (201), exhaust gas outlet (203), a rotating shaft (205), with porous media like catalyst blocks (204) being filled between turbo blades (202), wherein it has means to cleanse the nitride oxide and particular matters from the exhaust gas while driving the reformer (1).

21. A fuel reformer of claim 18, wherein it further has means of supplying fuel by an atomizer with a rotating arm (101) which has multiple atomization orifices (102), wherein the fuel is pressured by the centrifugal force of (101) and atomized through rushing out its orifices (102).

22. A fuel reformer of claim 18, wherein it has means of supplying fuel by a injection nozzle (105), wherein the injected spray is further atomized by the smashing force of the rotating arm (101′) which has small smashing bars (102′) fixed on it.

23. A fuel reformer of claim 18, wherein the catalyst rotor (103) is only partially filled with catalyst block (103a) in circular direction to reduce weight and save usage of catalyst.

24. A fuel reformer of claim 18, wherein the said rotation coupling shaft (12) is driven by a turbo (2).

25. A fuel reformer of claim 18, wherein the said rotation coupling shaft (12) is driven by at least one of following means: an electric motor, a turbine, an internal combustion engine.

26. A fuel reformer of claim 20, wherein the air inlet (107), the steam inlet (106) is co-axial with the said rotation coupling shaft (12).

27. A fuel reformer of claim 20, wherein the air inlet (107), the steam inlet (106) is offset with the said rotation coupling shaft (12).

28. A fuel reformer of claim 18, wherein the rotation coupling shaft is a single shaft connection between the fuel reformer (1) and the rotation driver (2).

29. A fuel reformer of claim 18, wherein the axis of the said fuel reformer (1) and rotation driver (2) is offset, wherein the rotation coupling shaft (12) delivers rotation through at least one of the following means: through gears to couple the rotations between the fuel reformer (1) and the rotation driver (2), through belt to couple the rotations between the fuel reformer (1) and the rotation driver (2).
